(19) United States
(12) Patent Application Publication
(10) Pub. No.: US 2007/0138453 A1
(43) Pub. Date: Jun. 21, 2007

(54) Leaf Catcher Device

(75) Inventor: David Ts Le, St Paul, MN (US)

Correspondence Address: DAVID LE, 1859 HOYT AVE E, ST PAUL, MN, 55119, US

(73) Assignee: David Ts Le, St Paul (US)

(21) Appl. No.: 11/306,236

(22) Filed: Dec. 20, 2005

(51) Int. Cl. E04H 17/00; A01D 46/22

(52) U.S. Cl. 256/1; 256/12.5

(57) ABSTRACT

A roll of nets are pre-treated or coated with attractive natural sticky glue gel is assembled on the roller device to lay down nets around the yard under tree and upright next by fence to catch fallen leaf and other lawn waste, and trap any small insects/mosquitoes. The nets roller device may use to retrieve netting with fallen leaves/debris on it to disposal or may reuse. The net may or may not be immediate turn to become “net bag” to waste fallen leaves/debris. The special tie loop can hold and tied up net bag. The special Guard Pins use to hold and secure the net to the ground/up right. The hollow core may use to contain all accessories in it.

### RELATED APPLICATIONS

There are no previously filed, nor currently any co-pending applications, anywhere in the world.

### 1. FIELD OF THE INVENTION

The invention relates to immediate collecting method and discards fallen leaves and traps any small insects/mosquitoes, and more particularly to a novel device allows roller technique.

### BACKGROUND OF THE INVENTION

This invention relates to the collection and disposable fallen leaves/debris, and traps any insect/mosquitoes and more particular to a novel method and roller device for such collection and disposal.

Many device and technique have been designed to provide the household in cleanup and removing fallen leaves/debris on the yard and garden. Leaves can be rake or use blower to become pile on the yard, sometime prohibited by law of local need to remove to clear up environment. Sometime piles of leaves can damage existing growing grass, and creating more insects.

U.S. Pat. No. 6,308,505 B1 issued Oct. 30, 2001.Show as Leaf rake device mounting to the tractor. The tractor equipped with hydraulic, A spring loaded locking hinge mechanisim allow to be raised, the design leaf raking tines and forward sweeping leaf rake to collect the leaves and piles up for disposal. Problem of this technique must use tractor to operate the leaf rake device.

U.S. Pat. No. 4,628,674, issued Dec. 16, 1986 Show as an leaf handling apparatus is provide which interactively combine the effects of a rake and an air blower. Using two adjustable handle to become nozzle to blow leaf. One of this problem must need use Air equipment to blow leaves.

U.S. Pat. No. 4,569,187 issue Feb. 1, 1986. Also one of mechanical machine to catching leaves, this device need more experience human to operating catching leaves.

U.S. Pat. No. 4,888,942 issue Dec. 26, 1989. Said the implement use to only pushing leaves and pile them up, this technique means to use wide rake blade to reach leaves and push leaves to mass pile.

U.S. Pat. No. 6,546,710 B1, issued Apr. 15, 2003, this device collecting leaves and grass still use tractor to operating the job done.

U.S. Pat. No. 3,762,454, issued for Wilkins, describes a disposable garbage container in the form of a bag.

U.S. Pat. No. 3,747,653, issued Jul. 24,1973, said metal bracket related to leaf bag can attached and bag holding for sweeping leaves therein.

None of the above device provide easy way, suffer way still involved, timely still not improved. Motivates consumer is not in good manner way.

The present invention is providing a device and method may be eliminated following old method blowing, hand raking, rake attached the tractor. The present device method also motivates consumer with confidents multi jobs done same time, timely effective, immediate disposable, instant collecting/disposal fallen leaves and any small insects/mosquitoes in just a quick small time needed.

### SUMMARY OF THE INVENTION

The technique and method to use netting laid out on the ground around the trees which area expected have fallen leaves. The size of net mesh enough to holding small leaves and enough to trapped any small insects/Mosquitoes. Before or after leaf fallen season over netting sheet can be bundle to disposal or continuous reuse. The bundle of netting may be immediate dump into garbage container. The present net device design unique for easy pulling the rope to rolling netting around yard by which horizontal or vertical when needed.

The netting have had pre-treat with natural gel glue material to trapped insects with no time involved. The netting device may be applied to reuse for other netting roll.

The net roll device contains several size of dimension to support consumer confidents to received what they need. The net Mesh with different size for more choice to decision need.

The rope would easy have extension in length if needed, with the hook just hook on the wheel shaft and ready to do the pulling job. The net roll device may provide different size in length to adapt dimension of consumer's yard need. The Net Guard Pin long enough applies to secure net on the ground and upright position. The wheel of the device is main purpose to delivery which easy way and simple enough to spread net around yard with different position lay out or upright. The core of netting device use to support for netting assemble to be rolling out, and the hollow core may be use for contain delivery accessories for net device.

The netting color it self attract enough to mosquitoes and other insects, netting color also merge in the grass color to avoid distract yard view. The netting pattern may be different shapes from square to diamond shape.

### BRIEF DESCRIPTION OF THE DRAWING

FIG. 1 is perspective view of rolling device show complete component parts

FIG. 2 is perspective view show in which netting on roll device of FIG. 1 with square pattern

FIG. 3 is perspective view show in which netting on roll device of FIG. 1 with diamond pattern

FIG. 4 is perspective is a front view of illustrating a known construction of a wheel

FIG. 5 is perspective is a side view of illustrating a known wheel attached with the core plug into hollow core

FIG. 6 is perspective is a front view of illustrating a known as guard pin with different lengh to secure net down close to the ground or upright net around fence position

FIG. 7 is perspective is a top view of illustrating FIG. 6 show

FIG. 8 is perspective is a completed component device have assembled show as top view

FIG. 9 is perspective is a completed component device have assembled show as bottom view

FIG. 10 is perspective is a completed component device have assembled show as side view

FIG. 11 is perspective is a completed component device have assembled show as front view

FIG. 12 is perspective is a completed component device have assembled show as rear view

FIG. 13 is perspective is a completed component device have assembled show normal view

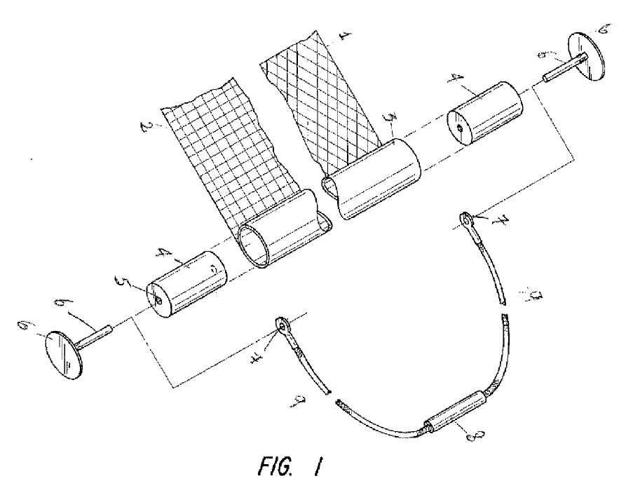

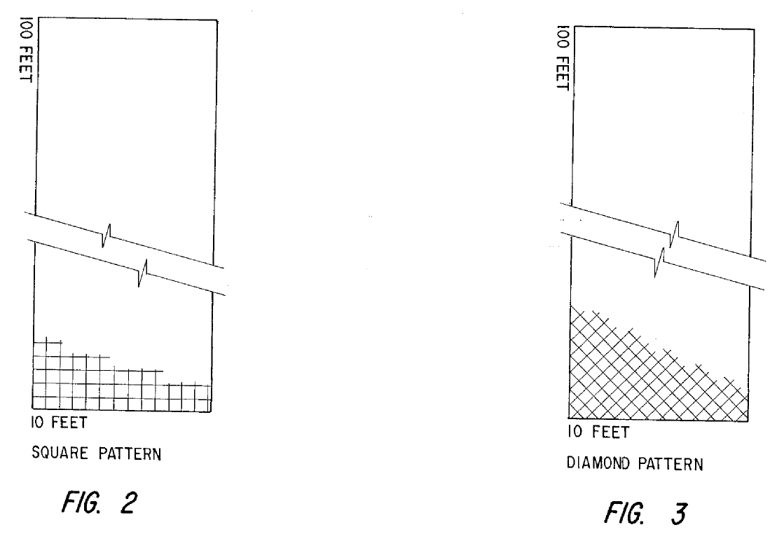

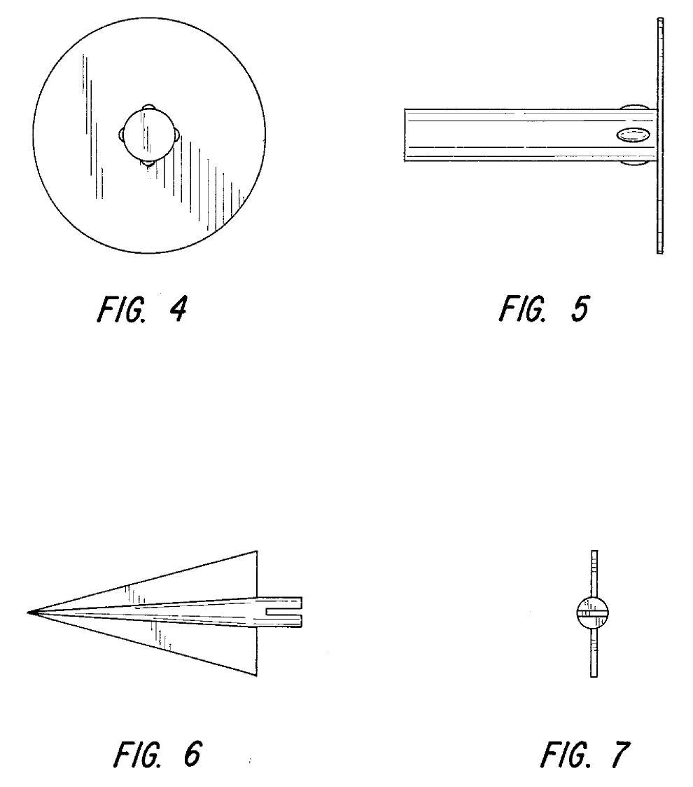

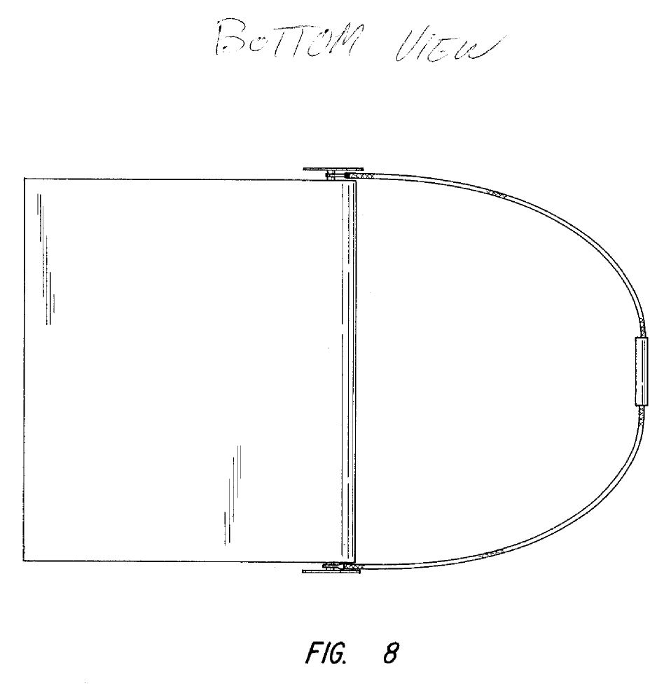

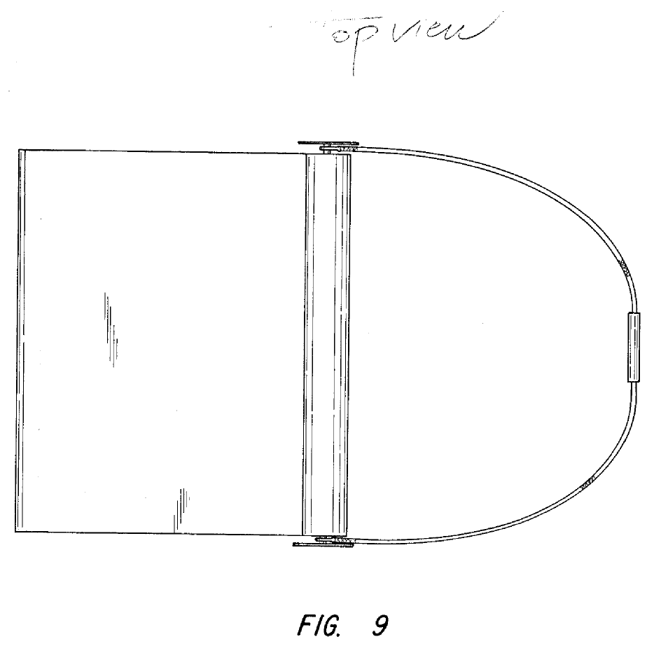

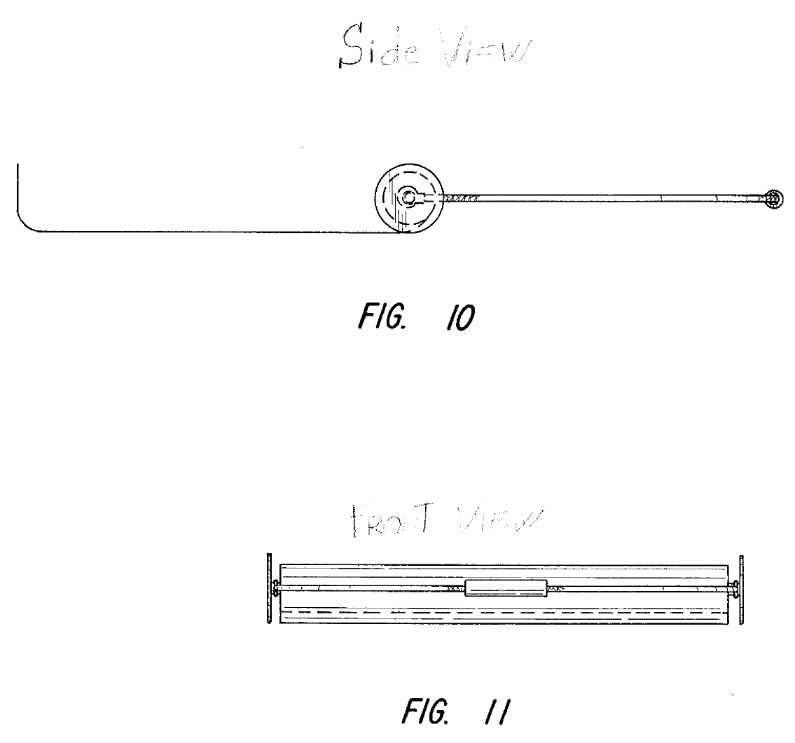

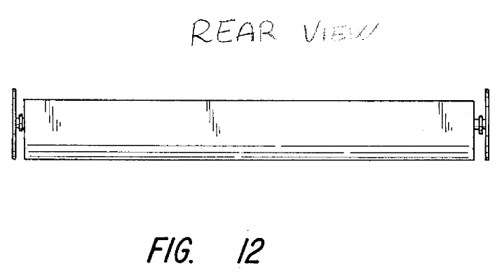

### DETAILED DESCRIPTION OF PREFERRED EMBODIMENTS

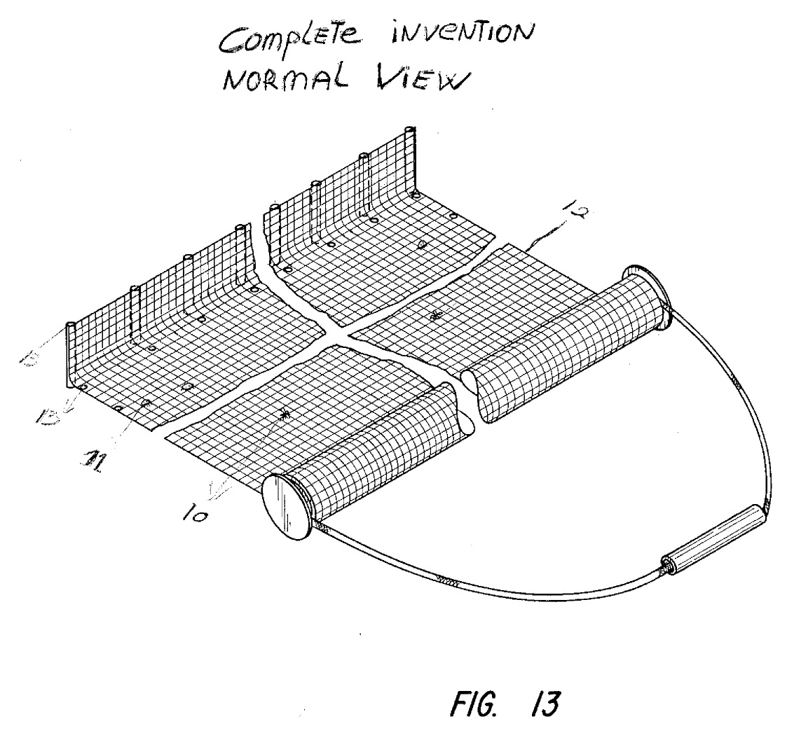

Leaf catching and insects/mosquitoes trap in this device show completed in FIG. 13 show perspective view in:

The netting 1 show with diamond mesh shape and dimension of mesh come with varies from ½ inches to 1½ inches or more to fitting the invention catching fallen leaves and trap any small insects needed, different length of netting can assembly in the hollow paper tub or plastic tube show on tub 3, this netting have pre treated or coated with gel glue to completed the invention has said.

The netting 2 show with square mesh shape and said dimension of mesh come with varies from ½ inches to 1½ inches or more to fitting the invention said, different length of netting may assembly in the tub 3 has said above, the netting have pre treated or coated with gel glue to completed the invention has said.

Hollow tub 3 has said above in 1,2, hollow tub or core may come with different dimension of diameter from ½ inches to 1½ inches or may larger or smaller to meet the invention need, the tube length start with different length to meet invention need, hollow tube may or may not use for contain packaging accessories for easy shipping method.

The insert core 4 small enough to insert into the hollow core or tube, this insert core/tube long enough to secure inside the hollow tube, 5 show at the end of this insert core/tube has closed and has an center opening hole design, this opening hole function as holding wheel shaft 6.

The length of wheel shaft 6 long enough to plug a potion of wheel shaft into the center opening 5 said, other potion left from out side wheel shaft about ½ inches opening for hook 7 assembly later time, wheel shaft also attach the wheel has capable rolling to delivery the entire rolling device travel around yard or fence, the wheel diameter large enough depend on the thickness of netting roll.

Hooks 7 also immediate a rope, this hook easy enough to install and uninstall any time into the wheels at shaft 6, this rope function as use to pulling device, the rope handle 8 also pre assembly as manufacture, this handle diameter large enough for easy holding handle technique, this rope long enough for different side of human user. Rope's handle 8 preinstalled on rope 9, The handle grip big enough for any size of hand can grab on it.

Rope 9 length long enough for all use and rope 9 is help to pull roll device around horizontal and vertical to spread netting on the ground or up right around fence.

Additional FIG. 13 show 10 is mosquitoes been trapped by gel glue

Additional FIG. 13 show 11 is insects/bugs been trapped by gel glue

Additional FIG. 13 show 12 is fallen leaf fall down on netting

Additional FIG. 13 show 13 is pin guard long enough to secure netting down the up right position

Reference Cites [Referenced By]

U.S Patent Documents

| | | | |
|---|---|---|---|
| 2801431 | August, 1957 | Eastis | 15/328 |
| 1618739 | February, 1927 | Wenzin | 256/1 |
| 4200127 | April, 1980 | Dunleavy | 56/329 |
| 2728099 | December, 1955 | Cocoo | 15/245 |
| 4467490 | August, 1984 | Adams | 15/245 |
| 3047998 | August, 1962 | Leader et al. | 56/202 |
| 3387346 | June, 1968 | Hasenbank | 24/270 |
| 4322936 | April, 1982 | Whitney | |
| 4409781 | October, 1983 | Blackstone | |
| 3315408 | April, 1967 | Fisher | 47/9 |
| 3704544 | December, 1972 | Spanel et | 47/9 |
| 4366949 | January, 1983 | Staub, Sr | 256/1 |
| 2790296 | April, 1957 | Bernstein | 56/400 |
| 2193070 | March, 1940 | Lambert. | |
| 4985961 | January, 1991 | Allen. | |

What is claimed is:

1. A roll netting device for rolling net with horizontal around the yard or vertical around the fence yard.

2. A roll netting device for catching fallen leaves/debris/other waste.

3. A roll netting device pre-treated gel glue for trapping any small insects/mosquitoes.

4. A roll netting device for disposal or reusable with leaves/debris.

5. A roll netting device for preventing any animal enter the yard.

6. A roll netting device for refillable.

7. A roll netting device for flexible netting secure end edge raise up higher to preventing leaves blow in and out to other yard.
